(19) United States
(12) Patent Application Publication
(10) Pub. No.: US 2005/0177859 A1
(43) Pub. Date: Aug. 11, 2005

(54) Video surveillance system and methods of use and doing business

(76) Inventors: Henry Valentino III, Las Vegas, NV (US); Jeremiah Morrill, Las Vegas, NV (US); Travis Whidden, Las Vegas, NV (US)

Correspondence Address: NATH & ASSOCIATES, 1030 15th STREET, NW, 6TH FLOOR, WASHINGTON, DC, 20005, US

(21) Appl. No.: 10/957,021

(22) Filed: Oct. 1, 2004

Related U.S. Application Data
(60) Provisional application No. 60/543,298, filed on Feb. 9, 2004.

(51) Int. Cl. H04N 7/18

(52) U.S. Cl. 725/105; 348/143

(57) ABSTRACT

Methods and systems for video surveillance and monitoring of at least one transaction terminal are provided. According to one method, a plurality of transaction terminal transactions are displayed to a user, each transaction terminal transaction being associated with a transaction identifier. The plurality of transaction terminal transactions are linked to video records of the transaction terminal transactions using the transaction identifiers. A user is allowed to select at least one transaction terminal transaction and at least one video record associated with the selected transaction terminal transaction is retrieved and displayed to the user.

### CROSS-REFERENCE TO RELATED APPLICATION

The present application claims priority to, and expressly incorporates by reference in its entirety, provisional U.S. patent application Ser. No. 60/543,298, filed Feb. 9, 2004, entitled Video Surveillance System and Methods of Use and Doing Business.

### FIELD OF THE INVENTION

The present invention relates to methods and systems for video surveillance and recording. Certain embodiments provide methods and systems for a user to view video of particular transactions carried out on a transaction terminal.

### BACKGROUND

Video surveillance systems for recording activity at a particular physical location are known in the art. Typically, these systems have been used to produce a video record that may be subsequently reviewed. Video surveillance has been used to monitor events such as automobile accidents, business or manufacturing operations, or other similar events.

Video surveillance has also been used to record physical actions associated with business transactions. These transactions may be executed at a transaction terminal, such as a point of sale terminal (POST). A POST is a computerized replacement for a cash register. A POST generally has the ability to carry out and record sales transactions and to connect to other systems in a network. The POST may have the ability to process credit and debit cards. Generally, a POST has a processor running application-specific programs and communicates with input/output devices for the particular environment in which it operates. A POST at a restaurant, for example, is likely to have applications relating to the menu items for sale at the restaurant.

These prior art surveillance applications have presented a number of disadvantages. One or more video cameras may record video of a particular location, such as a POST, workstation, or location of interest. A number of such locations may be subject to surveillance. Each camera may provide a continuous video feed. Therefore a surveillance operation often produces continuous video records for multiple cameras, which results in an enormous amount of data. One disadvantage associated with some prior art systems is that periodic replacement of the storage device, such as video tape, was required, which increases set up and maintenance costs.

Another disadvantage of typical prior art surveillance applications is that, because of the large amount of video data generated by these systems, it typically has been difficult to locate a particular video segment of interest in the overall video record. If a user desires to find and review a particular video record, such as to identify why cash is missing from the POST, the entire video record must be reviewed. However, even viewing the video record of a single eight hour work shift at a relatively high speed can take a reviewer a good deal of time. Furthermore, more than one viewing may be necessary in order to find the video segment of interest. Although U.S. Pat. No. 6,698,021 purports to disclose a digital system for real-time off-site storage of digital video, a routine for selecting an event of interest out of the video record is not provided.

Prior art surveillance using video tapes typically suffer from additional disadvantages. The tape often must be reviewed at the location where the tapes are stored. Even if the tapes can be viewed elsewhere, the tape must typically be viewed in its entirety, is time consuming and cumbersome to scan and review, and is reviewable only by one play-back machine at a time.

### SUMMARY OF THE INVENTION

The present invention provides video surveillance systems and methods of their use. Certain embodiments provide method of doing business using the disclosed systems or methods. According to at least one embodiment, video signals from one or more cameras associated with a transaction terminal are recorded. In one embodiment where multiple cameras are used, each camera may record a different angle of a transaction terminal, e.g., a cash drawer, so that one camera will capture useful images even when the other camera is obscured. In another embodiment, particularized video identifiers, such as a time stamp, for example, are included in the video record.

In one embodiment, at least one video camera records video of a transaction terminal. A transaction terminal, as used herein, may include, without limitation, a cash-register, POST, game table, gaming device, bank window, automatic teller machine, security point (such as a locked door), change window, etc. The transaction generates signals indicative of the nature of the transaction being conducted. Each transaction signal may be associated with a transaction identifier, such as the date and the time of its production.

The transaction signals may be analyzed and acted upon. In one embodiment, the transaction signals may be viewed and searched by a user. In an alternate embodiment, the transaction signals may be automatically compared to a predetermined threshold. If the threshold is exceeded, a notification signal may be generated. For example, a particular transaction signal may correspond to the length of time a cash drawer is left open. If this time exceeds a predetermined threshold, a notification signal may be generated. The notification signal may be used to alert a user, or to flag the transaction for later review.

In certain embodiments of the invention, a register of transaction signals is maintained. The transaction register may include data related to transactions carried out at the transaction terminal, such as the nature of the transaction, the identity of an employee who carried out the transaction, and how long the transaction took. The transaction identifier may also be recorded in the transaction register. A user may access or query the transaction register.

In certain embodiments, data from the video cameras is transmitted to a video server. The video server may process the video signals, such as by resolving and storing individual frames in succession. In at least one embodiment, after a certain file size is reached, or a predetermined time period has elapsed, the video record is moved to a video database server comprising, for example, disk storage. Alternatively, the transaction register may be maintained on the video database server.

Certain embodiments provide systems and methods for more efficient storage of video records. The system may examine stored video records and delete records that meet certain criteria. For example, video records may be deleted once a certain time has passed. Also, video records that are outside of a business's normal operating hours may be purged.

Other embodiments provide a viewing station. The viewing station may be used to view transaction records, live video, and/or archived video. The viewing station may be networked with system components, including the transaction terminal, the video database server, and/or the video server, via a local network, a virtual private network (VPN), the Internet, or an intranet. The viewing station may be proximate to or remote from any of the system components. In at least one embodiment, the viewing station is remote from the video database server. In other embodiments, a remote viewing station is networked to other system components through a viewing station, which acts as a conduit.

A user interface system, such as a graphical user interface (GUI), may be provided on a display at the viewing station or the remote viewing station. The GUI may include video controls such as zoom and playback controls. In certain embodiments, the GUI may allow a user to assemble a custom video clip of transactions of interest. The GUI may also allow a user to select live or still images from one or more cameras.

Other embodiments allow a user to use the viewing station or remote viewing station to view video associated with a transaction of interest. One or more transactions may be displayed to the user. The user may select a transaction using the GUI. For example, the user may choose to view video records of transactions involving a particular employee, a particular transaction terminal, or of a particular type. In at least one embodiment, the user may enter a query which is compared to the transaction register.

In at least one embodiment of the invention, a transaction identifier, such as the time stamp, is correlated to a video identifier corresponding to the same transaction. The video record of the transaction may then be retrieved and displayed to the user. In this way, video associated with a transaction of interest may be directly accessed without the need to scan through video records or to separately enter an identifier.

The methods and systems of the present invention may be integrated with or retrofitted to network systems currently using transaction terminals. For example, existing video and information feeds may redirected from other tasks and used with embodiments of the present invention. Video can be redirected from cameras, such as, but not limited to, security cameras. Information feeds can include existing or new data datastreams, such as accounting and inventory control data streams.

It is to be understood that this Summary of the Invention lists various aspects of various embodiments of the present invention. Additional aspects of the present invention will become apparent as this specification proceeds.

It is also to be understood that all features noted above need not be included in a given embodiment in order for the embodiment to fall within the scope of the present invention, and that not all deficiencies noted in the prior art need be overcome by a given embodiment in order for it to fall within the scope of the present invention.

### BRIEF DESCRIPTION OF THE DRAWINGS

The preferred embodiments of the present invention are shown and described in connection with the following drawings in which:

FIG. 1 is a diagram illustrating an embodiment of a system for capturing, storing, and retrieving transaction terminal records and video data;

FIG. 2 is a flow chart illustrating methods of storing video records generated by the system of FIG. 1;

FIG. 3 is a flow chart illustrating the management of video records generated by the system of FIG. 1;

FIG. 4 is an illustration of a point of sale terminal which may be used in embodiments of the system of FIG. 1;

FIG. 5 illustrates an embodiment of a graphical user interface where a user may enter search criteria to find transaction signals, and associated video records, of interest;

FIG. 6 is a flow chart illustrating an embodiment of a method of comparing transaction signals to thresholds to generate trigger signals;

FIG. 7 is an illustration of an embodiment of a trigger register and also illustrates an embodiment of a graphical user interface that may be used at a viewing station to select video records for review;

FIG. 8 is an embodiment of a graphical user interface where a user may select camera views and select various actions to take;

FIG. 9 illustrates an embodiment of a graphical user interface for interacting with a live video feed; and

FIGS. 10A and 10B illustrate an embodiment of a graphical user interface for interacting with an archived video record.

### DETAILED DESCRIPTION OF THE PREFERRED EMBODIMENTS

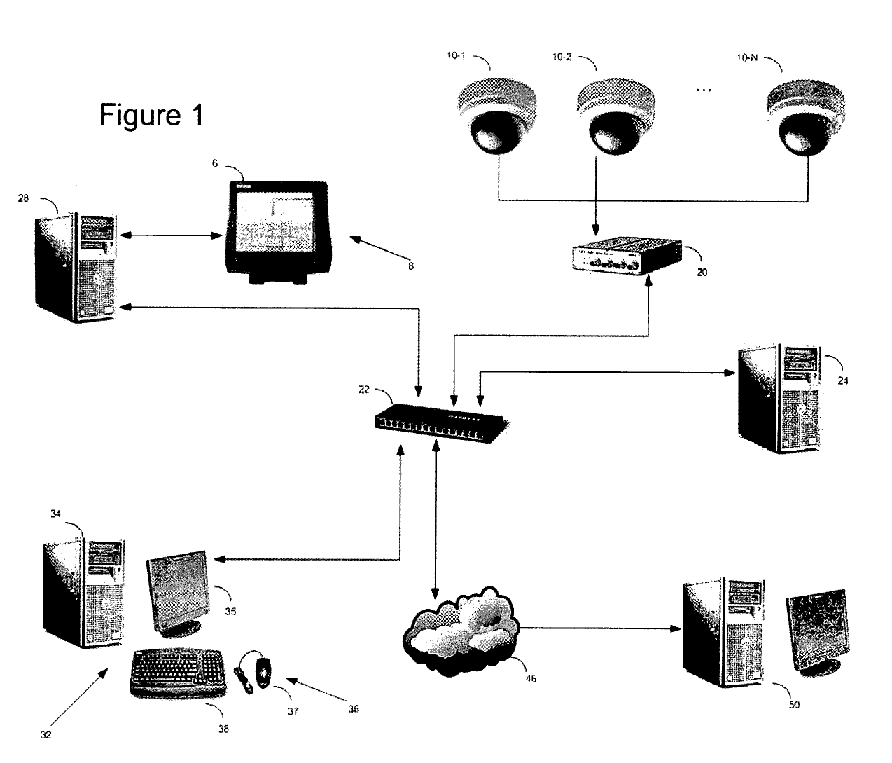

FIG. 1 illustrates a system 1 which may register transactions at or associated with a transaction terminal 6 monitored by video cameras 10. Transaction terminal 6, may be, but is not limited to, a point of sale terminal (POST). One suitable transaction terminal 6 is the Micros 8700 workstation, available from MICROS Systems, Inc. of Columbia, Md.

The transaction terminal 6 produces separately identifiable signals, transaction signals, indicative of different types of transactions that a business owner or manager may wish to monitor. The transaction signals may be produced in response to actions of an employee operating the transaction terminal 6 or by condition-responsive sensors (not shown).

The transaction terminal 6 may be placed at a location 8. At least one camera 10 monitors location 8 or another location of interest associated with the transaction terminal 6. In certain embodiments, a plurality of cameras 10 are used. Each camera 10 may focus on the same field of view, but from different angles. Alternatively, one or more cameras 10 may focus on other fields of view, such as employee or customer areas, rather than the transaction terminal 6.

The cameras 10 are connected to a video server 20, which may be an Axis 2400 Video Server made by Axis Communications of Lund, Sweden. The video server 20 multiplexes and encodes the output of the cameras 10. In one embodiment, the video server 20 encodes the camera output as a series of JPEG (Joint Photographic Experts Group) images. Depending on the frame rate, the video stream may comprise an M-JPEG (motion JPEG, a format used for streaming) video stream. Other video standards may be used, including Windows Media. In at least some embodiments, the video sever 20 supports multiple encoding standards.

The video sever 20 is connected to an Ethernet switch 22, which is in turn connected to a video database server 24, over a network connection. In at least one embodiment, the video database server 24 is a personal computer. As used herein, a network connection may comprise, and network communication may occur using, a local network, a virtual private network (VPN), an Intranet, or the Internet. Any suitable communication protocol may be used, including TCP/IP or UDP/IP.

Transactions are recorded at transaction terminal 6 which provides transaction signals to a transaction server 28. The transaction server 28 may be a Micros Transaction Server, available from MICROS Systems, Inc. of Columbia, Md. The transaction server 28 is coupled to the Ethernet switch 22 for network communication. Transactions may be recorded stored in the video database server 24, which may thus act as a transaction server. In at least certain embodiments, the video database server 24 is configured to seamlessly integrate with existing system components, such as the transaction server 28.

Management or other personnel may enter queries and view records at a viewing station 32, which may be connected to the Ethernet switch 22 via a network connection. The viewing station 32 may comprise a local computer 34, a display 35, and an interface 36. The interface 36 may comprise a pointing device 37, such as a mouse and a keyboard 38. The local computer 34 may be a personal computer running a Windows based operating system and the display 35 may be a monitor.

The viewing station 32 may serve as an administration station which may be accessed by remote users at remote stations 50 over a network connection. In certain embodiments, access to the viewing station 32 may be provided on a subscription basis. A user at a remote station 50 may log in to the system 1 through local computer 34, which may act as a server, validating usernames and passwords. The viewing station 32 may be located on an open or closed network. The network may be closed in order to provide a higher level of security. In other embodiments, a remote user may directly access system 1, including over a local area network, an intranet, the Internet, a virtual private network, or any other suitable means. In one embodiment, a business provides system 1 as a service to a client and the business maintains a webserver that may be accessed remotely by the client.

In the manner described below, the system 1 may provide video records from each camera 10 and provide a record of transactions at the transaction terminal 6. At the viewing station 32, for example, video records can be accessed, such as by querying the video database server 24 for transaction records or video segments. At the user interface 36, a user need only select a transaction record in order to retrieve and view a video recording associated with the selected transaction. In some embodiments, a user may access video records by entering a particular time and date, or other video identifier. In certain embodiments, a user may choose to view archives for a particular camera.

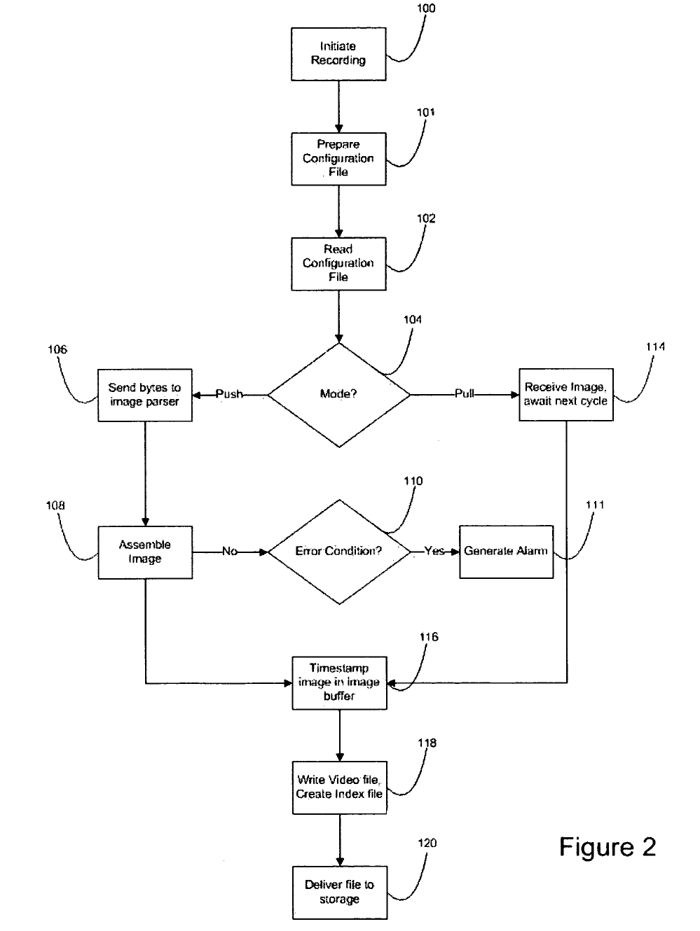

FIG. 2 illustrates a method of acquiring video data and storing video records. At step 100, a thread is initiated to record JPEG data. Normally a separate thread is initiated for the output from each camera 10 (FIG. 1). The video streams from each camera 10 are multiplexed as known in the art. At step 101, a user prepares a configuration file for the video server 20 (FIG. 1). At step 102, the video server 20 reads the configuration file. At decision 104, the method determines whether the video server 20 is set to a server push mode or to a client pull mode, respectively used for higher or lower data rates, in accordance with the configuration file. If the video server 20 is set to the server push mode, the method proceeds to step 106.

At step 106, incoming bytes are sent to an MJPEG image parser. At step 108, an image is assembled. Image production is monitored at decision 110, which detects error conditions. It may be beneficial to monitor image production because access to the video feed can be lost by the video server 20. In some cases, this loss of access is due to the interaction of the MJPEG recording software with the TCP/IP (transmission control protocol/internet protocol) process providing the video feed. If decision 110 indicates that the video feed has been interrupted, an alarm will be generated at step 111. This alarm could take the form of an e-mail sent to the viewing station 32 (FIG. 1). If no error condition is detected, the method proceeds to step 116.

Referring back to decision 104, if the video server is set to the client pull mode, the method proceeds to step 114. At step 114, an image is received and sent to the buffer image manager for processing at step 116. The video server then awaits the beginning of the next image storage cycle.

At step 116, the image buffer manager associates a video identifier, such as a time stamp, with the image and sends the image to an image buffer. At step 118, the image buffer creates an index file and writes a video data file. The index file may cache information, including frame count, byte pointers for each frame, and a time and date stamp indicating when each frame was received.

When a video data file of a predetermined size is recorded, or a predetermined time has passed, the video data file is sent to storage, as indicated at step 120. In a presently preferred embodiment, video files are created hourly. In the embodiment of FIG. 1, the video server 20 writes video record to the video database server 24. The video records may be stored elsewhere without departing from the scope of the present invention. Disk fragmentation of files within the video database server 24 may be avoided by recording an entire file in buffer storage before writing the file to the video database server 24. Reduced disk fragmentation may result in superior video playback.

Certain embodiments of the present invention provide a method of managing video records, such as those stored in the video database server 24. The program for managing records may reside in the video database server 24. However, since the video database server 24 is in a network, this is not necessary. For example, the record management program could reside in the viewing station 32.

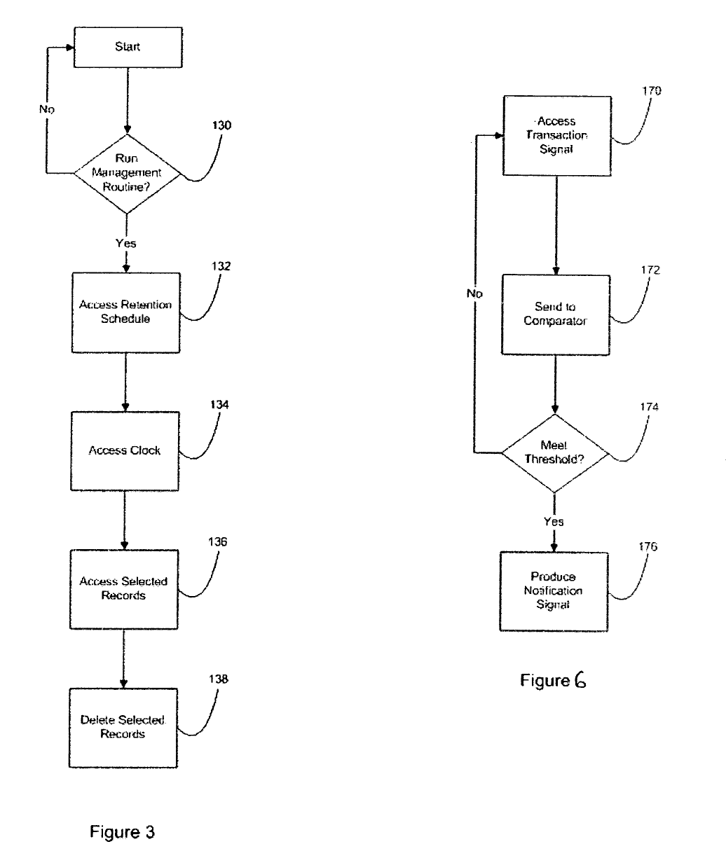

One aspect of record management comprises deleting video records no longer deemed necessary. Deleting video records more efficiently uses the storage capacity of the video database server 24 or other storage devices. FIG. 3 illustrates one embodiment of a record management routine. This routine may be run periodically, e.g., once a day. The record management routine may be implemented via a user-defined retention schedule, which may be in the form of a table. The retention schedule may indicate that video older than a certain date should be deleted, or that video recorded during certain hours of the days should be deleted.

The management routine is initiated at decision 130 which checks to see whether it is time to run the record management routine. If so, the method accesses the retention schedule at step 132. At step 134, a system time in a clock, such a clock inherent in the video database server 24, is accessed and that time is compared to the retention schedule. When indexed by their time stamps, the video records may be accessed by their time stamps, as indicated at step 136, and compared to the current time and the retention schedule. Video records that should be deleted according to the retention schedule are deleted at step 138.

In an alternate embodiment, video data is automatically deleted from, or not transferred to, the video database server 24 if no contemporaneous transaction signal is recorded. For example, a user may determine that a transaction signal will be generated within one minute of any given transaction. Therefore, if more than a minute passes without a transaction signal being generated, a video image may be marked for deletion. This embodiment further reduces the amount of storage space needed on the video database server 24.

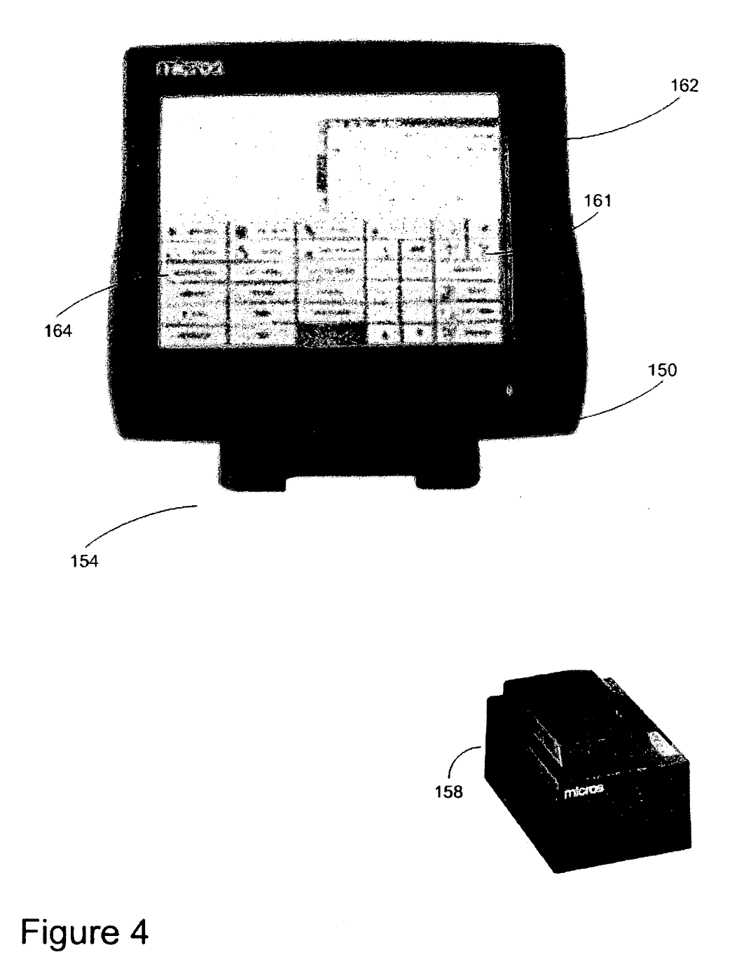

As discussed above, certain embodiments of the present invention may be used with a transaction terminal, such as a point of sale terminal (POST). One suitable POST is the Micros 8700 POS terminal made by Micros Systems Inc. of Columbia, Md. With reference to FIG. 4, a POST 150 may be included in an operator station 154 along with a cash drawer 156 and receipt printer 158. The POST 150 may comprise an input device 161, such as a keyboard, mouse, or touch screen for entering information. A display 162, which may include the touch screen, includes several fields for carrying out various operations and for entering information.

For example, the display 162 may include numbers for data entry in a number field 164. A mode field 165 comprises keys for selecting a mode of operation, e.g., employee sign in, food ordering, management functions, or other sorts of operations further described below. A selection field 166 provides keys for selecting a particular operation within a mode.

Transaction signals may be generated for various information that a user may wish to monitor. The type of transaction signals may depend on the particular application of system 1. Transaction signals may be produced for various events. The transaction signals may be stored as transaction records and may be accessed using the viewing station 32 or remote station 50.

Examples of transaction signals that may be monitored in a restaurant setting are presented in the table below. The table summarizes various commands and their respective functions. Each command listed in the table comprises one or more transaction signal.

| Command | Description |
|---|---|
| ADJUST_CHECK | an operator (e.g. a server or manager) makes an adjustment to a |
| | check, and the POST 150 registers the check number, table number |
| | and identification of the operator |
| ALL | all trigger events sent to viewing station 32 |
| BEGIN_CHECK\ | notes the opening of a check for a party at a table and registers the |
| | check number, table number and operator id |
| CLOCK_IN | allows use of the POST as a time clock and registers the |
| | employee's number |
| CLOCK_OUT | registers the employee number of a person clocking out |
| CLOSE_CHECK | used when a check for a given table is completed and no further |
| | entries are to be made; the check number, table and operator id are |
| | registered |
| DSC | indicates entry of a discount; an object number is assigned to the |
| | discount and registered along with a count of discount transactions |
| | and the total amount of the discount; the id of the person issuing the |
| | discount is also registered |
| DSC_VOID | utilized to void a discount; an object number is assigned to the |
| | discount void and registered along with a count of discount |
| | transactions and the total amount of the discount void; the id of the |
| | person voiding the discount is also registered |
| ERR_MSG | machine-generated error message |
| EXT_AUTH | registers external authorizations, such as credit card authorizations |
| HRD_ERR | reports a hard error and is not registered, rather requiring operator |
| | corrective action |
| MGR_PROC | indicates that a management procedure has been selected and run; a |
| | code number or name indicative of the procedure is recorded |
| MI_RET | indicates return of a menu item; an object number assigned to the |
| | transaction is recorded along with a count number and a total |
| | amount |
| MI_VOID | indicates that a menu item is voided; recorded in the same manner |
| | as a menu void |
| NO_SALE | used to register a transaction when the cash drawer is opened in the |
| | absence of a sale; a notation is registered that the NO_SALE |
| | occurred |
| PICKUP_CHECK | notes that a check has been taken from the table - check number, |
| | table number and operator id are registered |
| REOPEN_CHECK | is utilized to note that a closed check has been reactivated; check |
| | number, table number and operator id are registered |
| RPT_GEN | used to note that preparation of a report was commanded; a |
| | sequence number is generated and recorded along with the name of |
| | the report |
| SFT_ERR | reports a further error condition |
| SIGN_IN | used to denote an employee's signing in at POST 150 - the |
| | employee number is registered |
| SIGN_OUT | is used to denote an employee's leaving POST 150; the employee |
| | number is registered |
| SRVC_TOTAL | denotes that a check is totaled; the total amount of the check is |
| | registered |
| SVC | denotes entry of a service charge; an object number assigned to the |
| | transaction is recorded along with a count of the number of such |
| | transaction and a total amount |
| SVC_VOID | denotes deletion of a service charge from a check; an object number |
| | assigned to the transaction is recorded along with a count of the |
| | number of such transaction and a total amount |
| SYS_AUTH | denotes a system authorization from an employee having a level of |
| | authority exceeding that of the primary operator; the authorizing |
| | employee's number and a system-generated authorization number |
| | are entered |
| TNDR | used to indicate that payment has been tendered for a check; an |
| | object number, count and total are registered |
| TNDR_VOID | used to indicate that an entered tender has been voided; an object |
| | number, count and total are registered |
| TRANS_CL | used to cancel a transaction, such as an operator hitting an incorrect |
| | key on the touch screen |
| CASH_DRAWR | a machine-generated signal generated when a cash drawer is closed |
| | to indicate the length of time the case drawer was open. Normally, |
| | entry of NO_SALE or TNDR will open the cash drawer and begin |
| | timing of the duration of the cash drawer's being open |

A user may choose to review the various transaction signals recorded by a transaction terminal 6 (FIG. 1) over a certain time period. For example, management may wish to review the number of discounts issued by an employee in a day. The length of time a cash drawer is opened may be of interest. Once a transaction of interest is identified, the user may employ the methods and systems of embodiments of the present invention in order to review video associated with the transaction of interest.

Data elements associated with the transaction signals may be individually monitored. For example, a data element associated with the DSC transaction signal is the amount of discount. The amount of the discount may be monitored, and a trigger signal generated if the discount exceeds a certain amount.

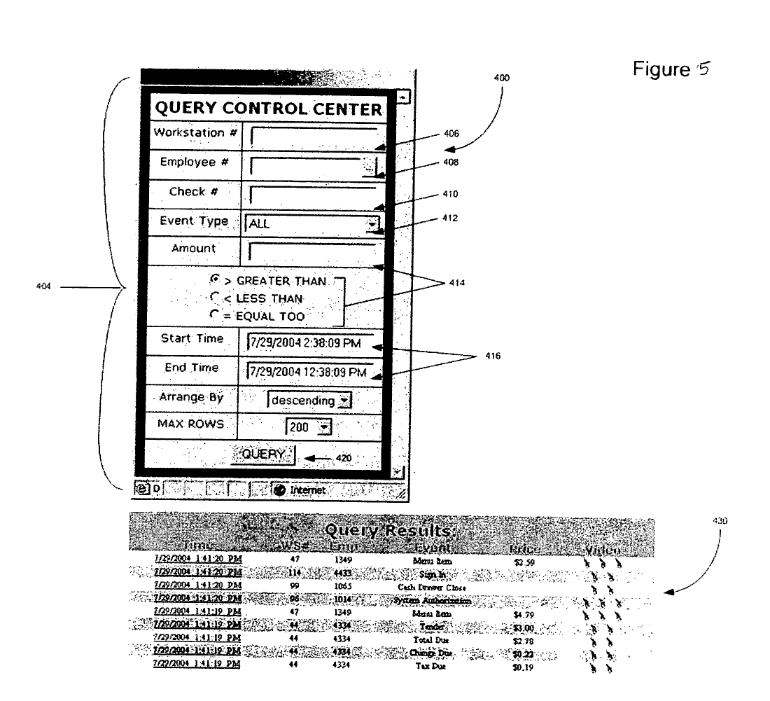

In addition to selecting events from the full transaction record, a user may be allowed to search the transaction record for transactions of interest. FIG. 5 presents a GUI 400 of a query screen that may be displayed at the viewing station 32 (FIG. 1) or a remote terminal 50 (FIG. 1). The GUI 400 includes a query entry form 404. A user may choose to search by transaction terminal 6 (FIG. 1) by entering the appropriate identifier in a workstation field 406. Records can be searched by employee I.D. in an employee field 408. If a specific check number, or other transaction identifier, is known, this can be searched by entering the number in a check field 410. An event type field 412 allows a user to search by type of event, such as return, discount, or override. An amount fields 414 allow search by transaction amount, which can be limited to amounts greater than, less than, or equal to the entered amount.

Query fields 406, 408, 410, 412, 414 can be limited as desired by the user. For example, the search can be limited by time and date using start time and end time fields 416. After the search is submitted by pressing a query button 420, matching transactions may be displayed in a query results table 430.

In addition to manual review of transaction signals, transaction signal review may be automated. Transaction signals may be automatically monitored and compared to threshold values. If a transaction signal exceeds the threshold, a trigger signal is produced. For example, trigger signals might be generated if the number of employee discounts exceeds a certain number in a day or if the cash drawer remains open longer than a certain time.

A separate table of trigger signals may be produced and made available for a user's review. In addition, a notification signal may be generated in order to call the triggering transaction to the user's attention. This notification signal might be an alarm, a pop up window on the screen of the viewing station 32 or a remote station 50, or an email generated and sent to the user's email account.

A method of monitoring transaction signals and generating trigger signals is summarized in FIG. 6. A transaction signal of interest is accessed at step 170. At step 172, the value of the transaction signal is provided to a comparator. At decision 174, the transaction signal is compared to a threshold value. If the transaction signal does not exceed the threshold, no further action is taken. If the transaction signal exceeds the threshold, the method proceeds to step 176 where the transaction signal is written to a table, called the trigger register, and a notification signal is produced. The trigger register provides a useful way for users to identify potentially relevant transactions without having to review all transactions.

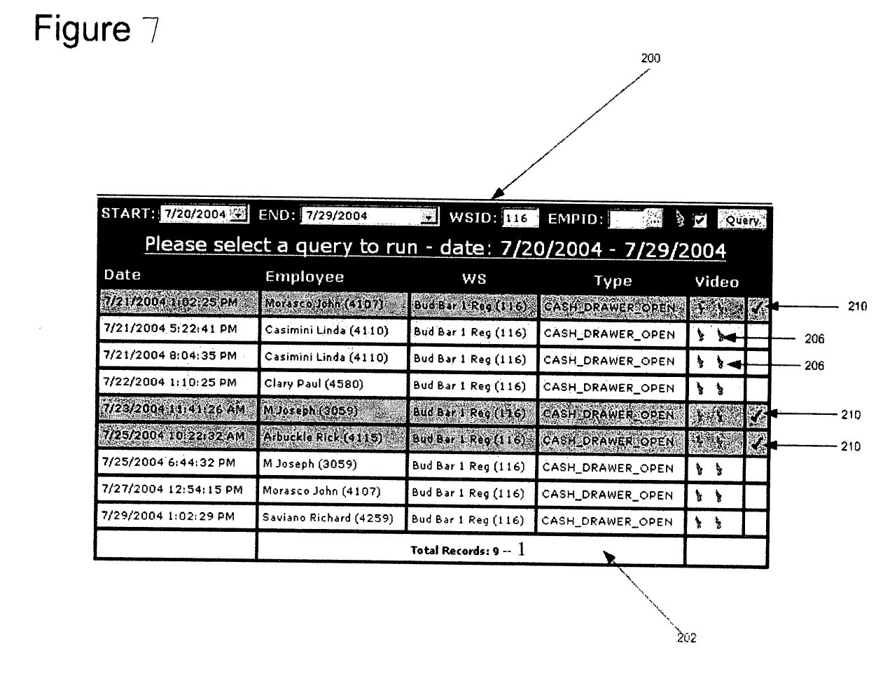

FIG. 7 is an illustration of an embodiment of a trigger register 200. The trigger register 200 may be displayed on the display 35 (FIG. 1) or a remote station 50 (FIG. 1) using a graphical user interface (GUI) 202. The trigger register 200 is shown having six columns representing: date and time, employed, workstation identity, type of trigger signal, video, and viewed.

The video column includes an icon 206 representing each camera 10 (FIG. 1) monitoring the workstation. The user may view a video clip recorded by a particular camera, and associated with the selected transaction, by selecting the appropriate camera icon 206. A check mark 210 may be placed in the “viewed” column if an operator at the viewing station 32, or a remote station 50, has viewed video associated with the trigger signal of its row. In certain embodiments, the trigger register 200 may indicate the identity of each user who has reviewed a particular transaction.

A user may use the input device 37 (FIG. 1) in conjunction with the GUI 202 to select a particular trigger record within the trigger register 200 and a particular camera icon 206. When a user selects a particular video record of an entry in the trigger register 200, a transaction identifier corresponding to the entry is accessed and correlated to a video identifier for the video record corresponding to the entry. For example, the time and date information listed in the date column of the trigger resister 200 may be correlated to a corresponding video record using the time index maintained in the video database server 24 (FIG. 1) or the video server 20 (FIG. 1).

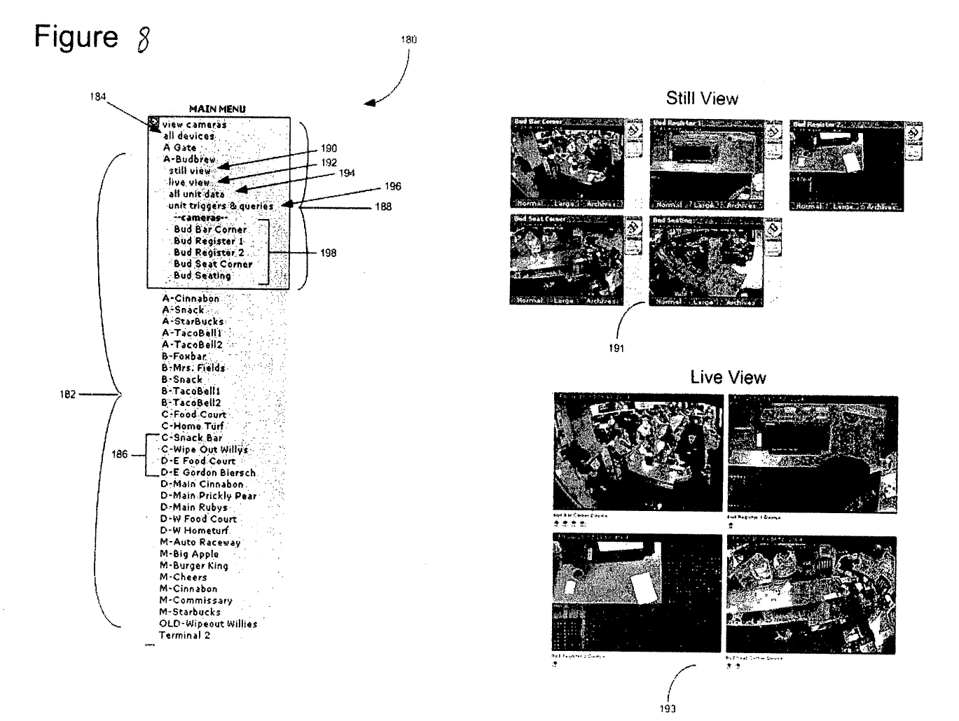

FIG. 8 illustrates an embodiment of a GUI 180 where a user may select video camera feeds to view and choose various actions to take. A selection menu 182 is provided that lists various commands a user may select. The selection menu 182 may include an all devices entry 184 which, when selected, shows still thumbnail views of all cameras in the system 1 (FIG. 1). A number of location entries 186 are listed in the selection menu 182.

If the user selects a location entry 186, the GUI 180 presents an action menu 188. In the action menu 188, a user may choose to see still images 191 of all cameras in the selected location by selecting a still view icon 190. Similarly, a user may choose to see live video 193 of all cameras in the selected location by a selecting live view icon 192.

The user may also choose to see transaction data associated with the selected location. For example, if the user selects an all unit data icon 194, the GUI 180 will present the user with the transaction data for every transaction terminal 6 (FIG. 1) at the selected location. The trigger register 200 (FIG. 7) will be displayed to the user if the user selects a triggers icon 196. The user may choose to see a combination of live video and live transaction data by selecting a particular location camera 198.

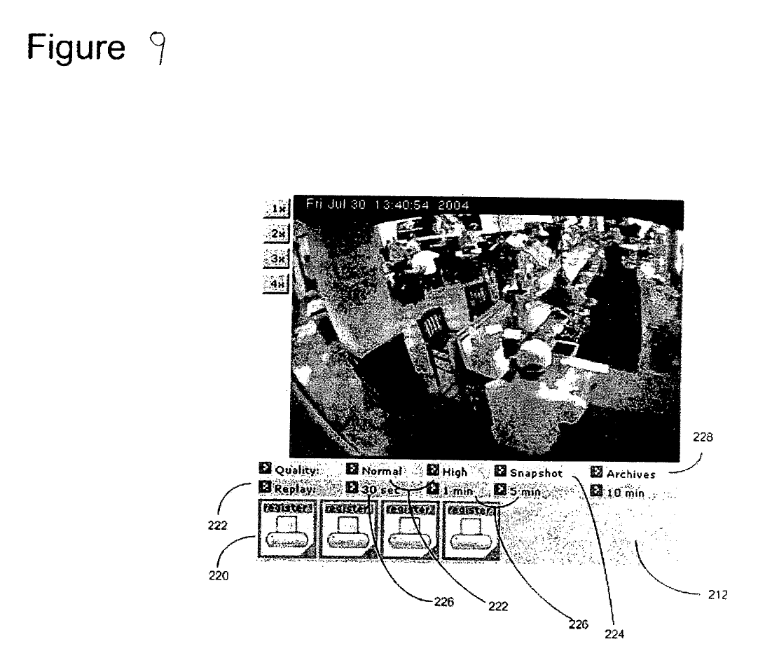

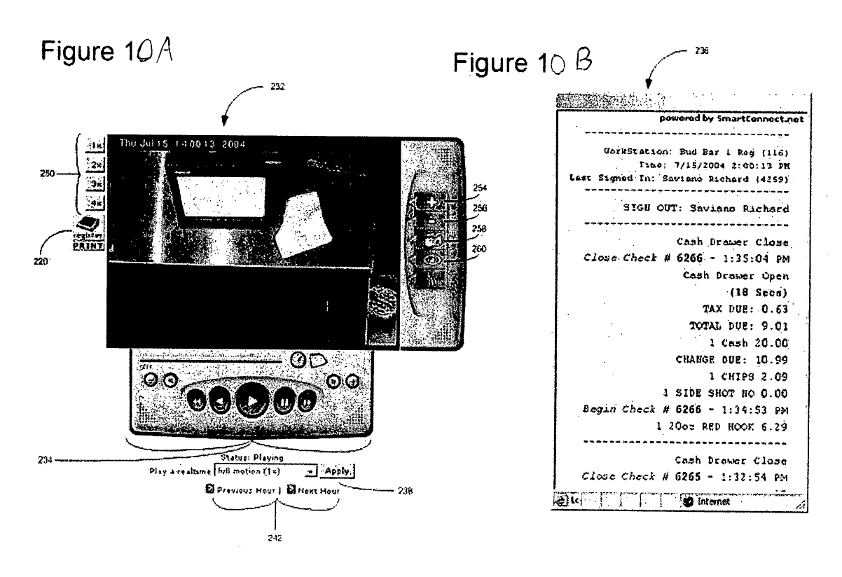

FIGS. 9, 10A, and 10B illustrate embodiments of a GUI 212 for manipulating video. FIG. 9 illustrates a GUI 212 that may be used with live video from a camera 10 (FIG. 1). The GUI 212 may be displayed at the viewing station 32 (FIG. 1) or a remote terminal 50 (FIG. 1). The GUI 212 has resolution buttons 222, which may be used to change the resolution of the video feed. A register button 220 may be used to open up the transaction register 200 (FIG. 7) and view transaction signals currently being generated by the transaction terminal 6 (FIG. 1) being monitored.

The GUI 212 may provide additional functionality. A snapshot of the currently displayed image can be recorded using a snapshot button 224. Replay buttons 226 may be used to access the video records and replay recent activity recorded by a camera 10. For example, video from 30 seconds, 1 minute, or five minutes from the current time may be instantly accessed using the replay buttons 226. An archive button 228 may be used to access archived video records, such as those stored on the video database server 24 (FIG. 1).

With reference to FIG. 10A, a GUI 232 may be provided for viewing and manipulating archived video records, such as those retrieved in connection with a transaction signal. Once the video record is accessed, the GUI 232 provides video player buttons 234. The video player buttons 234 may provide standard playback features such as forward, reverse, fast forward, fast reverse, go to beginning, go to end, pause, and stop.

A selector 238 provides for selection of a mode of playback, e.g. full motion. A user may use video record selector buttons 242 to select a particular video record to view. In one embodiment, separate video files are created for each hour of the video record. The video record selector buttons 242 may be used to select video corresponding to a particular hour or day. A user may also use the video record selector buttons 242 to view video from the preceding or subsequent hour to the video record currently being viewed. If multiple cameras are used to monitor a transaction terminal 6 (FIG. 1), a user may choose which camera feed to view using view buttons 246.

The transaction register button 220 may again be provided to access transaction signals associated with the video being viewed. In one embodiment, when the transaction register button 220 is selected, a transaction display 236 is displayed. The GUI 232 may be provided with zoom buttons 250 so that a user can zoom in and out of the video record.

Custom record buttons 254, 256, 258, 260 may be provided to enable production of a new video record using archived video records. The custom record buttons 254, 256, 258, 260 are identified, respectively, as Start Frame, Stop Frame, Download and Snapshot. The download button 254 may be selected to download a video record that begins with a frame selected by pressing the Start Frame button 256 and ending with a frame selected by pressing the Stop Frame button 258. Alternatively, a single frame may be downloaded when the Snapshot button 260 is selected. The downloaded video segment or frame may be stored on the video database server 24 (FIG. 1) or the viewing station 32, downloaded to a remote viewing station 50 (FIG. 1), or transmitted to another location (such as in an email attachment).

Embodiments of the present invention may find use in a variety of areas. In addition to restaurants, embodiments of the present invention may be used in casinos. For example, video cameras may be set to monitor gaming devices such as slot machines, video poker machines, and the like. The UDP/IP datastream generated by a slot machine may be monitored. Transaction signals may be generated for actions such as jackpot payouts, hopper fills, and security exceptions, a type of error code issued by the slot machine. When a transaction signal is generated, a video device can be set to record video, such as video of the environment around a slot machine. In embodiments using continuous recording, the transaction signal can be associated with the appropriate video segment to facilitate later review.

Similarly, table games and/or a sportsbook area may be monitored using embodiments of the present invention. For example, the issuance or redemption of markers may generate a transaction signal.

Embodiments of the present invention may be used to monitor the activity of casino patrons. Casinos often use player tracking systems to award comps to players. Typically, a player is given a card that may be scanned at gaming devices, game tables, restaurants, cashier cages, and other casino locations. The player transaction cards may be used to generate transaction signals. Embodiments of the present invention may allow a user to view video transactions associated with a particular player. This may find many uses. For example, if a player's card is stolen, or used inappropriately (as defined by rules), certain embodiments of the present invention may allow an operator to identify the thief by reviewing the video associated with the player's card.

Systems and methods of certain embodiments of the present invention may be used in the retail industry. In addition to monitoring POST at stores, embodiments may be used for inventory control. For example, many stores use inventory control devices to identify when items have left the premises without being deactivated by an employee. Such an event may be classified as transaction signal and may be used to identify and retrieve video associated with the incident. Certain embodiments may generate a transaction signal whenever an item above a certain threshold value is removed from the store. This video may be used by law enforcement authorities or other proceedings. The warehouse industry may use embodiments of the present invention in an analogous manner to track shipments entering and departing a warehouse.

The banking industry is another area where embodiments of the present invention may be used. Certain embodiments may be used for security purposes, such as monitoring areas like safety deposit boxes and vaults. Some embodiments may be used to monitor bank tellers. Transaction signals may be generated allowing users to later view video associated with a particular teller, a particular customer, a type of transaction, or transactions having a value above a threshold. These methods may be useful in fraud recovery. For example, if a fraudulent transaction takes place, video associated with a customer name or transaction can be reviewed in an attempt to identify the party perpetrating the fraud.

Embodiments of the present invention may be used for security purposes, such as identifying who has entered or left a location at a particular time. For example, I.D. cards or badges used to gain access to areas may generate transaction signals. Later, a user may review video by location, time, or employee. As an example, these embodiments could be used to monitor secure areas of an airport. Other embodiments may be used to control access to places such as rooms and elevators. These embodiments may find use in, for example, the hotel industry.

Certain embodiments of the present invention provide methods and apparatus permitting the creation of a continuous video record of an entire time period while providing the ability to efficiently retrieve a video record associated with a particular transaction. Users no longer need to perform time consuming frame-by-frame analysis of video records in order to locate segments association with a transaction of interest. The video records can be reviewed remotely and by multiple users simultaneously.

Virtually any action associated with business being conducted may be used to generate transaction signals. Although transaction signals may be generated for events involving physical actions, the systems and methods of embodiments of the present invention are not so limited. Embodiments of the present invention provide for efficient use of storage media, such as disks, in a video server or video database server. The systems and methods of embodiments of the present invention may be used to reliably and rigorously monitor employee actions in a variety of contexts and in a wide range of industries.

Embodiments of the present invention may be integrated into presently existing video and transaction networks. This can be accomplished by redirecting existing data streams, such as video feeds and transaction signals, and processing them according to embodiments of the present invention. Video can be redirected from cameras, such as security cameras. Information feeds can include existing accounting and inventory control data. In one embodiment, the system is constructed by retrofitting an existing retail network with software to perform the functions described herein.

The above descriptions of the preferred embodiments will enable those skilled in the art to make many departures from the particular examples described above to provide methods and systems constructed in accordance with the present invention. The embodiments are illustrative, and not intended to limit the scope of the present invention.

1. A method of video surveillance and monitoring of a transaction terminal, the method of video surveillance and monitoring comprising:
displaying a plurality of transaction terminal transactions to a user, each transaction terminal transaction being associated with a transaction identifier;
linking the plurality of transaction terminal transactions to video records of the transaction terminal transactions using the transaction identifiers;
allowing a user to select a transaction terminal transaction from the plurality of transaction terminal transactions;
retrieving a video record associated with the transaction terminal transaction selected by the user; and
displaying to the user a video record of the transaction terminal transaction selected by the user.

2. The method of claim 1, wherein the step of presenting a plurality of transaction terminal transactions to a user comprises displaying the plurality of transaction terminal transactions on a screen viewable by the user.

3. The method of claim 1, wherein the step of displaying to the user a video record of the transaction terminal transaction selected by the user comprises displaying a video clip on a screen viewable by the user.

4. The method of claim 1, the step of retrieving a video record associated with the transaction terminal transaction selected by the user comprising retrieving a video clip from a database.

5. The method of claim 4, further comprising transmitting video clip to the screen over an internet connection.

6. The method of claim 1, further comprising:
allowing the user to enter search parameters,
querying a database to locate transaction terminal transactions matching the search parameters entered by the user;
wherein the transaction terminal transactions matching the search parameters entered by the user are among the plurality of transaction terminal transactions presented to the user.

7. The method of claim 1, further displaying live video of a transaction terminal to the user.

8. The method of claim 7, contemporaneously with the step of displaying live video of a transaction terminal to the user, displaying live transaction terminal transaction data to the user.

9. The method of claim 1, further comprising:
recording video image data corresponding to a plurality of transaction terminal transactions;
associating video image identifiers with the video image data;
associating a transaction identifier with each of the plurality of transaction terminal transactions;
storing the video image data, the video image identifiers, and the transaction identifiers in a database; and
associating each transaction terminal transaction with video images corresponding to the transaction terminal transaction.

10. The method of claim 9, wherein the video image identifiers comprise a time stamp and the transaction identifiers comprise a time stamp.

11. The method of claim 1, the step of linking the plurality of transaction terminal transactions to video records of the transaction terminal transactions using the transaction identifiers comprises associating the transaction identifiers with video identifiers associated with the video records of the transaction terminal transactions.

12. The method of claim 1, each transaction terminal transaction comprising transaction data, further comprising:
analyzing the transaction data of the plurality of transaction terminal transactions to determine if a predetermined threshold has been exceeded;
if the predetermined threshold has been exceeded, generating a notification signal indicating to the user that the predetermined threshold has been exceeded.

13. The method of claim 12, wherein the transaction terminal is a point of sale terminal, the transaction data comprising the time a cash drawer associated with the point of sale terminal is left open, and the predetermined threshold is a predetermined time.

14. The method of claim 1, further comprising deleting expired video records of the transaction terminal transactions

15. A computing application of the type useable to display video images of a transaction terminal, the computing application comprising:
(A) a user interface system having:
(a) a transaction termination transaction display screen configured to display a plurality of transaction terminal transactions to a user;
(b) a user input component configured to allow a user to select at least one of the plurality of transaction terminal transactions;
(c) a video display screen configured to display to the user video images of the selected transaction terminal transaction;
(B) a data import facility configured to retrieve transaction data and video data, the video data comprising video images of at least one of the plurality of transaction terminal transactions;
(C) a data export facility configured to transmit user requests to a video database server;
(D) a search system in communication with the user interface system and the video database server, the transaction terminal transactions comprising transaction identifiers and transaction signals, the video data comprising video identifiers, the search subsystem further in communication with the transaction signals, the transaction identifiers, and the video identifiers, the search subsystem comprising a search algorithm that associates transaction identifiers with corresponding video identifiers.

16. The computing application of claim 15, further comprising a notification system comprising a comparison algorithm having a threshold value, wherein the comparison algorithm compares the transaction signals to the threshold value and generates a notification if the threshold value is exceeded.

17. The computing application of claim 15, the user interface system further comprising a transaction query screen, the query screen allowing a user to input a query to be processed by the search system.

18. The computing system of claim 17, further comprising a search results screen comprising transaction terminal transactions retrieved in response to the query and links to video images from the video data corresponding to the transaction terminal transactions retrieved in response to the query, wherein the user may select a link and the video images corresponding to the selected transaction terminal transaction will be displayed on the video display screen.

19. A surveillance system of the type useable to monitor transactions at a transaction terminal, the surveillance system comprising:
(A) a transaction terminal that generates transaction signals representing particular transactions carried out on the transaction terminal;
(B) a camera proximate the transaction terminal and operative to capture video data comprising images of the transaction terminal associated with the particular transactions carried out on the transaction terminal;
(C) a transaction marker in communication with the transaction terminal, the transaction marker operable to associate a first marker with the transaction signal generated by the transaction terminal for a first transaction carried out on the transaction terminal;
(D) a video marker in communication with the video data, the video marker operable to associate a second marker with video data associated with the first transaction;
(E) a database at least associating the first marker with the second marker; and
(F) a viewing station in communication with the database, whereby an operator may access the database and view the video data associated with the first transaction.

20. A method of video surveillance and monitoring of a transaction terminal, the method of video surveillance and monitoring comprising:
recording video images of a transaction terminal during a first transaction;
generating a transaction signal corresponding to the first transaction;
associating a video image identifier with the video images;
associating a transaction signal identifier with the transaction signal;
associating the video image identifier with a corresponding transaction signal identifier; and
at a viewing station, allowing an operator to view the video images by selecting the first transaction.
